(19) United States
(12) Patent Application Publication
(10) Pub. No.: US 2025/0349915 A1
(43) Pub. Date: Nov. 13, 2025

(54) INTELLIGENT DEVICE, BATTERY PACK INFORMATION INPUT METHOD, AND COMPUTER-READABLE MEDIUM

(71) Applicant: JIANGSU DONGCHENG TOOLS TECHNOLOGY CO., LTD., NANTONG, JIANGSU (CN)

(72) Inventors: YADONG CUI, NANTONG, JIANGSU (CN); CHUNLEI LU, NANTONG, JIANGSU (CN)

(21) Appl. No.: 18/870,448

(22) PCT Filed: Jan. 25, 2024
(86) PCT No.: PCT/CN2024/073934

§ 371 Date: Nov. 29, 2024

(30) Foreign Application Priority Data
Feb. 11, 2023 (CN) 202310101899.5

(51) Int. Cl. H01M 10/42

(52) U.S. Cl. CPC H01M 10/4257; H01M 2010/4278

(57) ABSTRACT

The present invention relates to an intelligent device, a battery pack information input method, and a computer-readable medium. The intelligent device includes a human-machine interaction module and an information conversion module and is configured to input information into a battery pack. The battery pack information input method includes: setting input information of a battery pack at the human-machine interaction module; the information conversion module converting the input information into configuration information that meets the communication requirements of the battery pack and sending the configuration information to the battery pack; the battery pack storing the configuration information into a memory; and the intelligent device reading the configuration information in the battery pack memory and compares and verifies the configuration information against the input information. The battery pack information input method enables the intuitive input of production information and charging and discharging information of the battery pack during production.

### CROSS REFERENCE TO RELATED APPLICATIONS

This application is a 35 U.S.C. § 371 National Phase conversion of the International Patent Application No. PCT/CN 2024/073934, filed on Jan. 25, 2024, which claims the priority of Chinese Patent Application No. 202310101899.5, filed Feb. 11, 2023, both of which are herein incorporated by reference in their entirety.

### TECHNICAL FIELD

The present disclosure relates to the field of power tools, and in particular to an intelligent device, a battery pack information input method, and a computer-readable medium.

### BACKGROUND

At this stage, a battery management system (BMS) of a battery pack mainly realizes an identification of performances, parameters and other information of the battery pack by setting different identification resistors or burning different software for different battery packs. However, both of these two approaches are defective. With the updating and iteration of technologies, due to the differences in battery cell types, charging and discharging capabilities, and the number of battery cells connected in series and/or parallel, refined categories of the battery packs have increased exponentially. It is no longer possible to distinguish the battery cells effectively by identification resistors. Burning different programs for different battery cells may cause confusion in the burned files, thereby resulting in problems such as missed or wrong burns.

In view of the above, it is necessary to design a battery pack information input method and an intelligent device, so as to overcome the defects of the related art.

### SUMMARY OF THE DISCLOSURE

According to an aspect, an intelligent device is provided. The intelligent device is configured to input information into a battery pack. The intelligent device includes a human-machine interaction module and an information conversion module. The human-machine interaction module is configured to set input information. The input information includes production information of the battery pack and charging and discharging information of the battery pack. The information conversion module is configured to convert the input information into configuration information that meets communication requirements of the battery pack.

According to a second aspect, a battery pack information input method is further provided. The information input method is performed by the intelligent device. The intelligent device includes the human-machine interaction module and the information conversion module. The information input method includes: connecting the battery pack to the intelligent device: setting the input information of the battery pack at the human-machine interaction module: sending, by the intelligent device, an access instruction to the battery pack: receiving, by the battery pack, the access instruction, and returning to the intelligent device an input grant instruction: converting, by the information conversion module, the input information into configuration information that meets communication requirements of the battery pack, and sending the configuration information to the battery pack, wherein the configuration information includes a high and low level information: receiving, by the battery pack, the configuration information, reading the configuration information and storing the configuration information into a memory: and reading, by the intelligent device, the configuration information in the memory of the battery pack, and verifying the configuration information against the input information.

According to a third aspect, another intelligent device is further provided. The intelligent device includes a memory and a processor. The memory stores a computer program that is capable of running on the processor. In response to executing the computer program, the processor implements an information input method. The information input method includes: connecting a battery pack to the intelligent device: setting input information of the battery pack at the human-machine interaction module: sending, by the intelligent device, an access instruction to the battery pack: receiving, by the battery pack, the access instruction, and returning to the intelligent device an input grant instruction: converting, by the information conversion module, the input information into configuration information that meets communication requirements of the battery pack, and sending the configuration information to the battery pack, wherein the configuration information comprises a high and low level information: receiving, by the battery pack, the configuration information, reading the configuration information and storing the configuration information into a memory: and reading, by the intelligent device, the configuration information in the memory of the battery pack, and verifying the configuration information against the input information

### BRIEF DESCRIPTION OF THE DRAWINGS

Hereinafter, embodiments of the present disclosure are described in further detail with reference to the accompanying drawings.

FIG. 1 is a schematic flowchart of an embodiment of the present disclosure.

FIG. 2 is a schematic flowchart of an automatic comparation verification process of the present disclosure.

FIG. 3 is a schematic flowchart of a manual comparation verification process of the present disclosure.

FIG. 4 is a modular diagram of an embodiment of the present disclosure.

### DETAILED DESCRIPTION

The present disclosure is described in further detail below in conjunction with the accompanying drawings and embodiments.

The terms adopted in the present disclosure are intended solely for describing particular embodiments and are not intended to limit the present disclosure.

A battery pack information input method described in the present disclosure is applicable to intelligent devices such as power tools/electric devices. As long as the above-mentioned devices/tools are capable of adopting substances of the technical scheme disclosed below; they would fall within the protection scope of the present disclosure.

Due to the rapid growth of battery pack refined categories, if the battery packs are distinguished by setting different identification resistors, a problem of difficulty in effectively distinguishing the identification resistors would be aroused, if the battery packs are distinguished by burning different software programs according to the battery packs, a problem of confusion in the burned files would be aroused. In response to the deficiencies of the related art, an object of the present disclosure is to provide a battery pack information input method and an intelligent device, which are capable of intuitively inputting production information and charging and discharging information of a battery pack during a production process of the battery pack, and the input method is simple and may input a much more amount of information. At the same time, the present disclosure provides a verification function, which may simply and directly verify whether the information stored in the battery pack is correct, and ensure that the input information is correct.

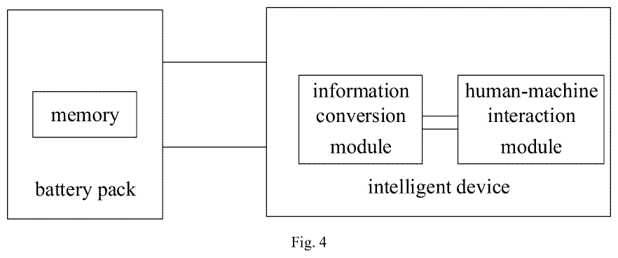

As illustrated in FIG. 4, to solve the existing technical problems of the related art, the present disclosure may adopt the following technical scheme of providing an intelligent device. The intelligent device includes a human-machine interaction module and an information conversion module. The intelligent device is configured to input the information into the battery pack. The human-machine interaction module is configured to set the input information. The information conversion module is configured to convert the input information into configuration information that meets communication requirements of the battery pack. The configuration information includes a high and low level information. The input information includes the production information of the battery pack and the charging and discharging information of the battery pack. The production information of the battery pack includes a production time, a production location, a production line identifier and a production amount. The charging and discharging information of the battery pack includes the number of battery cells, series-parallel configuration information of the battery cells, performance of the battery cells, brands of the battery cells, maximum charging current of a single battery cell and maximum discharging current of a single battery cell. The performance of the battery cell may be electrode sheet parameters of the positive and/or negative electrode, a composition of the electrolyte, an energy storage density; a cycle life, a conversion efficiency, etc.

The human-machine interaction module is a module with an operational display interface. An operation personnel may set the input information of the battery pack on the human-machine interaction module. The information conversion module includes a data conversion serial port. The information conversion module is configured to convert the input information into the configuration information that meets the communication requirements of the battery pack, and send the configuration information to the battery pack. The battery pack is configured to read the configuration information and store the configuration information into a memory.

A plurality of information windows are provided in the human-machine interaction module. The information windows include a production information window and a charging and discharging information window. The operation personnel may select the information window on an interface of the human-machine interaction module, and fill in relevant information according to the battery pack to be input with information, so as to simply and intuitively set the information for the battery pack.

A variety of different format information is stored internally in the information conversion module. A format conversion of the various types of information is realized through the information conversion module, so that the information may meet the requirements for communication with the battery pack, thereby implementing the configuration of the battery packs.

The intelligent device is configured to obtain, through interaction with the battery pack. the communication requirements of a communication protocol of the battery pack, and then feed the communication requirements to the information conversion module, such that the information conversion module may convert, according to the communication requirements, the input information into information that is recognizable by the battery pack.

The communication requirements include: performing a transmission of the configuration information through the high and low level information. In an optional embodiment, the communication requirements may further include: the transmission of the configuration information is implemented by using a handshake protocol. A specific configuration of the handshake protocol may be a common protocol form in this field. and would not be elaborated herein.

The intelligent device may be configured to send a reading instruction to the battery pack. The intelligent device may also be configured to receive the configuration information sent from the battery pack, and perform a verification step. The verification step includes an automatic comparison verification process and a manual comparison verification process. The automatic comparison verification process includes: automatically comparing, by the intelligent device, the configuration information with the input information, so as to verify whether the configuration information input into the battery pack is correct. The manual comparison verification process includes: displaying, by the intelligent device, the received configuration information on the human-machine interaction module: and comparing, by an operation personnel, the configuration information input into the battery pack with the battery pack information, and verifying whether the configuration information input into the battery pack is consistent with the battery pack information.

When the automatic comparison verification process is adopted, the consistency of the information may be automatically identified and confirmed without an intervention of the operation personnel, thereby enhancing an automatic degree of the system. When the manual comparison verification process is adopted, the interaction between the system and the operation personnel may be increased. The operation personnel may set an error tolerance rate through the human-machine interaction module. When the consistency degree reaches a certain level, such as 95%, the information is considered as consistent, so as to enhance a controllability of the error tolerance rate. The error tolerance rate may be set according to actual conditions. As a result of the above technical scheme, a personalized verification setup may be realized.

In general, after the configuration information of the battery pack is input, the consistency is confirmed by the automatic comparison verification process. The manual comparison verification process is mainly used for processes of product sampling or quality inspection. In this way, an accuracy of the configuration information is further enhanced through a unified automatic verification and manual sampling and quality inspection process.

In comparation with the related art. the present disclosure provides the intelligent device. The operation personnel may intuitively set the production information and the charging and discharging information of the battery pack and input the same into the battery pack through the intelligent device. In this way, the problem of prone to errors in the input information may be effectively avoided, and much more information may be input. The demand brought about by the rapid growth of the battery pack refined categories may be satisfied. At the same time, the intelligent device may read the configuration information stored in the battery pack, to verify whether the input information is correct. The consistency between the input information and the battery pack is thus guaranteed.

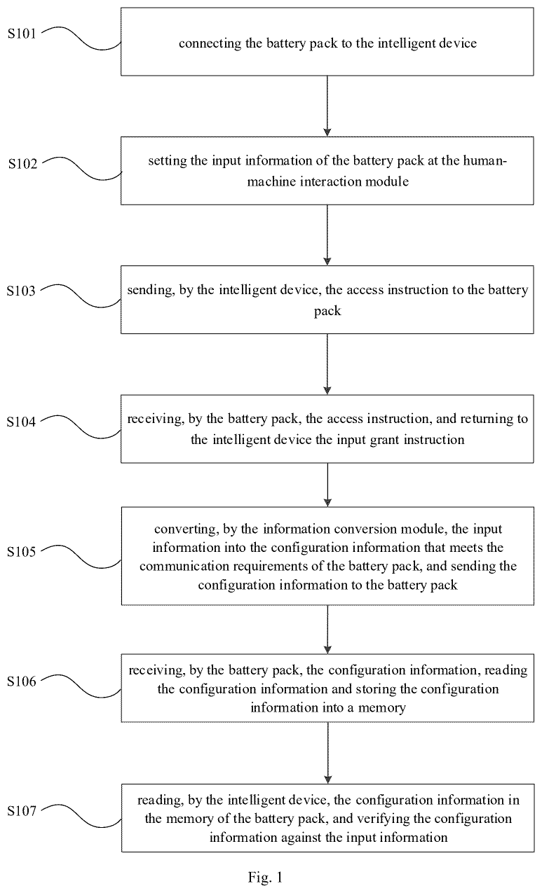

A battery pack information input method is further provided in the present disclosure. As illustrated in FIG. 1, the information input method is performed by the intelligent device. The intelligent device includes the human-machine interaction module and the information conversion module. The information input method includes operations at blocks illustrated in FIG. 1. In the operation of S101: connecting the battery pack to the intelligent device. In the operation of S102: setting the input information of the battery pack at the human-machine interaction module. In the operation of S103: sending, by the intelligent device, an access instruction to the battery pack. In the operation of S104: receiving, by the battery pack, the access instruction, and returning to the intelligent device an input grant instruction. In the operation of S105: converting, by the information conversion module, the input information into the configuration information that meets the communication requirements of the battery pack, and sending the configuration information to the battery pack. The configuration information includes the high and low level information. In the operation of S106: receiving, by the battery pack, the configuration information: reading, by the battery pack, the configuration information: and storing, by the battery pack, the configuration information into the memory. In the operation of S106: reading, by the intelligent device, the configuration information in the memory of the battery pack, and verifying, by the intelligent device, the configuration information against the input information.

The plurality of information windows are provided in the human-machine interaction module. The information windows include the production information window and the charging and discharging information window. The operation personnel may select the information window on the interface of the human-machine interaction module, and fill in the relevant information according to the battery pack to be input with information, so as to simply and intuitively set the information for the battery pack.

A variety of different format information is stored internally in the information conversion module. The format conversion of the various types of information is realized through the information conversion module, so that the information may meet the requirements for communication with the battery pack, thereby implementing the configuration of the battery pack. The intelligent device is configured to obtain, through the interaction with the battery pack, the communication requirements of the communication protocol of the battery pack, and then feed the communication requirements to the information conversion module, such that the information conversion module may convert, according to the communication requirements, the input information into the information that is recognizable by the battery pack.

The communication requirements include: performing the transmission of the configuration information through the high and low level information. In an optional embodiment, the communication requirements may further include: the transmission of the configuration information is implemented by using the handshake protocol. The specific configuration of the handshake protocol may be a common protocol form in this field. and would not be elaborated herein.

The verification step includes the automatic comparison verification process and the manual comparison verification process.

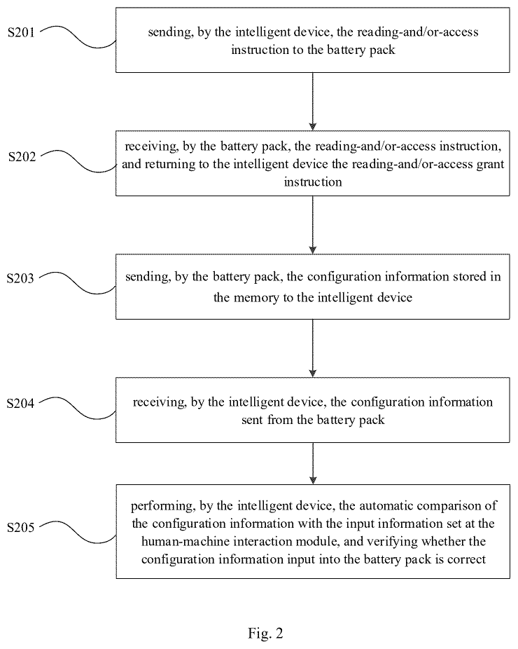

The automatic comparison verification process includes the operations at blocks illustrated in FIG. 2. In the operation of S201: sending, by the intelligent device, the reading and access instruction to the battery pack. In the operation of S202: receiving. by the battery pack, the reading and access instruction, and returning to the intelligent device a reading—and/or—access grant instruction. In the operation of S203: sending, by the battery pack, the configuration information stored in the memory to the intelligent device. In the operation of S204: receiving, by the intelligent device, the configuration information sent from the battery pack. In the operation of S205: performing. by the intelligent device, an automatic comparison of the configuration information with the input information set at the human-machine interaction module, so as to verify whether the configuration information input into the battery pack is correct.

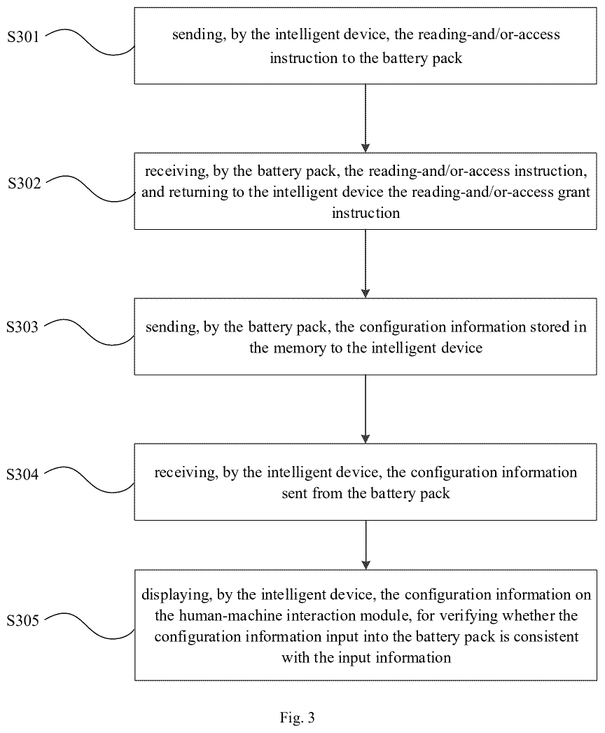

The manual comparison verification process includes the operations at blocks illustrated in FIG. 3. In the operation of S301: sending, by the intelligent device, the reading and access instruction to the battery pack. In the operation of S302: receiving, by the battery pack, the reading and access instruction, and returning to the intelligent device a reading-and/or-access grant instruction. In the operation of S303: sending, by the battery pack, the configuration information stored in the memory to the intelligent device. In the operation of S304: receiving, by the intelligent device, the configuration information sent from the battery pack. In the operation of S305: displaying, by the intelligent device, the configuration information on the human-machine interaction module, so as to verify whether the configuration information input into the battery pack is consistent with the input information.

When the automatic comparison verification process is adopted, the consistency of the information may be automatically identified and confirmed without an intervention of the operation personnel, thereby enhancing the automatic degree of the system. When the manual comparison verification process is adopted, the interaction between the system and the operation personnel may be increased. The operation personnel may set the error tolerance rate through the human-machine interaction module. When the consistency degree reaches a certain level, such as 95%, the information is considered as consistent, so as to enhance the controllability of the error tolerance. As a result of the above technical scheme, a personalized verification setup may be realized.

In general, after the configuration information of the battery pack is input, the consistency is confirmed by the automatic comparison verification process. The manual comparison verification process is mainly used for processes of product sampling or quality inspection. In this way, the accuracy of the configuration information is further improved through the unified automatic verification and manual sampling and quality inspection process.

The input information includes the production information of the battery pack and the charging and discharging information of the battery pack. The production information of the battery pack includes the production time, the production location, a production line and the production amount. The charging and discharging information of the battery pack includes the number of the battery cells, series-parallel configuration information of the battery cells, the performance of the battery cells, the brands of battery cells, the maximum charging current of a single battery cell and the maximum discharging current of the single battery cell. The performance of the battery cell may be the electrode sheet parameters of the positive and/or negative electrode, the composition of the electrolyte, the energy storage density, the cycle life, the conversion efficiency, etc.

The battery pack information input process is configured to perform, during a production process of the battery pack and after the assembly of the battery pack is completed, the information input for the battery pack. The information of the battery pack is input into the memory through the information input method.

For a communicable battery pack, the battery pack information is input according to the information input method. The communicable battery pack may include, for example, a module that supports wireless communication protocols such as the Bluetooth, the Wi-Fi, etc., or may include other common interfaces for communicating with intelligent terminals. The other common interfaces may for example be a USB interface, a Type-C interface, etc. The interaction with the intelligent device is realized through the above-mentioned modules/interfaces, so as to obtain the configuration information of the battery pack.

For an incommunicable battery pack, a separate read/write port is designed on the battery pack. The read/write port may be configured to communicate with the intelligent device, for inputting the battery pack information according to the information input method. The connection to an appointed read/write port is conduct through a dedicated device. The dedicated device may interact with the intelligent device, so as to obtain the configuration information of the battery pack.

In comparation with the related art, in the present disclosure, the battery pack information input method is provided, which is capable of intuitively inputting the production information and charging and discharging information of the battery pack during the production process of the battery pack. The input method is simple, and more information may be input. At the same time, the present disclosure provides the verification function, which may simply and directly verify whether the information stored in the battery pack is correct, and ensure that the input information is correct. In the present disclosure, an information tracing function of the battery pack may be realized, and the production information of the battery pack may be read. During the charging or discharging process of the battery pack, it is possible to adopt the charging or discharging parameters that match the performance of the battery pack for different battery packs, so as to ensure a safe use.

A computer-readable medium is further provided in the present disclosure. The computer-readable medium includes a non-volatile program code executable by a processor. The program code is configured to enable the processor to perform the method of the second embodiment.

In comparation with the related art, the present disclosure provides the intelligent device. The intelligent device is configured to input information into the battery pack. During the production process of the battery pack, the input information may be set intuitively. The intelligent device is capable of verifying whether the input information is correct. The problem of ineffective distinction between battery packs through identification resistors caused by identifying the resistors or confusion of burned files caused by burning software programs in the related art may be effectively avoided. In the present disclosure, in the context of the rapid growth of the battery pack refined categories, a simple and direct input of the battery pack information is satisfied, and at the same time, the information of the battery pack may be traced back.

Those of ordinary skills in the art should appreciate that, the embodiments of the present disclosure may be implemented as a method, a tool or a computer program product. Thus, the present disclosure may adopt the form of entire hardware embodiments, entire software embodiments, or embodiments that combine software and hardware aspects. Further, the present disclosure may adopt the form of a computer program product implemented on one or more computer usable storage media. The computer usable storage media includes, but is not limited to, a magnetic disk memory, a CD-ROM, an optical memory etc. A computer usable program code may be contained in the computer usable storage medium.

The present disclosure is described with reference to flowcharts and/or block diagrams of methods, devices (tools), and computer program products according to the embodiments of the present disclosure. Each process and/or block in the flowcharts and/or block diagrams, and the combination of processes and/or blocks in the flowcharts and/or the block diagrams, may be implemented by computer program instructions. These computer program instructions may be provided to the processor of a general-purpose computer, a specialized computer, an embedded processor or other programmable data processing device to generate a machine, which enables the instructions performed by the processor of the computer or another programmable data processing device to generate an apparatus. The apparatus is configured to achieve the function specified in one or more processes in the flowcharts and/or in one or more blocks of the block diagrams.

These computer program instructions may also be stored in a computer-readable memory capable of directing a computer or other programmable data processing device to operate in a particular manner, such that the instructions stored in the computer-readable memory may produce a manufacture article that includes an instruction apparatus. The instruction apparatus achieves the function specified in one or more processes of the flowcharts and/or one or more blocks of the block diagrams.

These computer program instructions may also be loaded into a computer or other programmable data processing devices, such that a series of operating steps are executed on the computer or the other programmable data processing devices to generate a processing achieved by the computer. In this way, the instructions executed on the computer or the other programmable devices provide steps for achieving the function specified in one or more processes of the flowcharts and/or one or more blocks of the block diagrams.

The above-described embodiments are merely specific implementations of the present disclosure, provided to illustrate, but not intended to limit, the technical schemes of the present disclosure. The protection scope of the present disclosure is not limited to these embodiments. Although the present disclosure has been described in detail with reference to the foregoing embodiments, those skilled in the art should understand that, within the disclosed technical scope of the present disclosure, any modifications or changes of the technical schemes described in the embodiments may still be made or occurred to those skilled in the art, or any equivalent replacements of certain technical features may still be made. All such modifications, changes, or replacements would not cause an essence of the corresponding technical schemes to be depart from the spirit and scope of the technical schemes of the embodiments of the present disclosure. and should be included within the protection scope of the present disclosure. Therefore. the protection scope of the present disclosure should be defined by the appended claims.

1. An intelligent device, configured to input information into a battery pack and comprising:
a human-machine interaction module, configured to set input information; wherein the input information comprises production information of the battery pack and charging and discharging information of the battery pack; the production information of the battery pack comprises a production time, a production line identifier; and
the charging and discharging information of the battery pack comprises series-parallel configuration information of the battery cells, a maximum charging current of a single battery cell and a maximum discharging current of the single battery cell;
an information conversion module, configured to convert the input information into configuration information that meets communication requirements of the battery pack, wherein the configuration information comprises a high and low level information.

2. The intelligent device as claimed in claim 1, wherein
the intelligent device is configured to: send a reading instruction to the battery pack, receive the configuration information sent from the battery pack, automatically compare the configuration information with the input information, and verify whether the configuration information input into the battery pack is correct.

3. The intelligent device as claimed in claim 1, wherein
the intelligent device is configured to: send a reading instruction to the battery pack, receive the configuration information sent from the battery pack, and display the configuration information on the human-machine interaction module, for verifying whether the configuration information input into the battery pack is consistent with the input information.

4. The intelligent device as claimed in claim 1, wherein
the human-machine interaction module is a module with an operational display interface, the input information of the battery pack is capable of being set through the human-machine interaction module;
the information conversion module comprises a data conversion serial port,
the information conversion module is configured to: convert the input information into configuration information that meets the communication requirements of the battery pack; and
send the configuration information to the battery pack; and
the battery pack is configured to read the configuration information and store the configuration information into a memory.

5. A battery pack information input method, wherein
the information input method is performed by an intelligent device, the intelligent device comprises a human-machine interaction module and an information conversion module,
the information input method comprises:
connecting a battery pack to the intelligent device;
setting input information of the battery pack at the human-machine interaction module;
sending, by the intelligent device, an access instruction to the battery pack;
receiving, by the battery pack, the access instruction, and returning to the intelligent device an input grant instruction;
converting, by the information conversion module, the input information into configuration information that meets communication requirements of the battery pack, and sending the configuration information to the battery pack, wherein the configuration information comprises a high and low level information;
receiving, by the battery pack, the configuration information, reading the configuration information and storing the configuration information into a memory; and
reading, by the intelligent device, the configuration information in the memory of the battery pack, and verifying the configuration information against the input information.

6. The information input method as claimed in claim 5, wherein the input information comprises production information of the battery pack and charging and discharging information of the battery pack.

7. The information input method as claimed in claim 6, wherein
the information input method comprises a verification step, the verification step comprises an automatic comparison verification process, and the automatic comparison verification process comprises:
sending, by the intelligent device, a reading and access instruction to the battery pack;
receiving, by the battery pack, the reading and access instruction, and returning to the intelligent device a reading-and/or-access grant instruction;
sending, by the battery pack, the configuration information stored in the memory to the intelligent device;
receiving, by the intelligent device, the configuration information sent from the battery pack; and
performing, by the intelligent device, an automatic comparison of the configuration information with the input information set at the human-machine interaction module, and verifying whether the configuration information input into the battery pack is correct.

8. The information input method as claimed in claim 6, wherein the information input method comprises a verification step, the verification step comprises a manual comparison verification process, and the manual comparison verification process comprises:
sending, by the intelligent device, a reading and access instruction to the battery pack;
receiving, by the battery pack, the reading and access instruction, and returning to the intelligent device a reading-and/or-access grant instruction;
sending, by the battery pack, the configuration information stored in a memory to the intelligent device;
receiving, by the intelligent device, the configuration information sent from the battery pack; and
displaying, by the intelligent device, the configuration information on the human-machine interaction module, so as to verify whether the configuration information input into the battery pack is consistent with the input information.

9. An intelligent device comprising a memory and a processor, the memory storing a computer program that is capable of running on the processor, wherein in response to executing the computer program, the processor is configured to implement an information input method,
the information input method is performed by the intelligent device, the intelligent device comprises a human-machine interaction module and an information conversion module,
the information input method comprises:
connecting a battery pack to the intelligent device;
setting input information of the battery pack at the human-machine interaction module;
sending, by the intelligent device, an access instruction to the battery pack;
receiving, by the battery pack, the access instruction, and returning to the intelligent device an input grant instruction;
converting, by the information conversion module, the input information into configuration information that meets communication requirements of the battery pack, and sending the configuration information to the battery pack, wherein the configuration information comprises a high and low level information;
receiving, by the battery pack, the configuration information, reading the configuration information and storing the configuration information into a memory; and
reading, by the intelligent device, the configuration information in the memory of the battery pack, and verifying the configuration information against the input information.

10. (canceled)

11. The intelligent device as claimed in claim 9, wherein
the input information comprises production information of the battery pack and charging and discharging information of the battery pack.

12. The intelligent device as claimed in claim 9, wherein
the information input method comprises a verification step, the verification step comprises an automatic comparison verification process, and the automatic comparison verification process comprises:
sending, by the intelligent device, a reading and access instruction to the battery pack;
receiving, by the battery pack, the reading and access instruction, and returning to the intelligent device a reading-and/or-access grant instruction;
sending, by the battery pack, the configuration information stored in the memory to the intelligent device;
receiving, by the intelligent device, the configuration information sent from the battery pack; and
performing, by the intelligent device, an automatic comparison of the configuration information with the input information set at the human-machine interaction module, and verifying whether the configuration information input into the battery pack is correct.

13. The intelligent device as claimed in claim 9, wherein
the information input method comprises a verification step, the verification step comprises a manual comparison verification process, and the manual comparison verification process comprises:
sending, by the intelligent device, a reading and access instruction to the battery pack;
receiving, by the battery pack, the reading and access instruction, and returning to the intelligent device a reading-and/or-access grant instruction;
sending, by the battery pack, the configuration information stored in a memory to the intelligent device;
receiving, by the intelligent device, the configuration information sent from the battery pack; and
displaying, by the intelligent device, the configuration information on the human-machine interaction module, so as to verify whether the configuration information input into the battery pack is consistent with the input information.

14. The intelligent device as claimed in claim 11, wherein
the production information of the battery pack comprises a production time, a production location, a production line identifier and a production amount; and
the charging and discharging information of the battery pack comprises the number of battery cells, series-parallel configuration information of the battery cells, performance of the battery cells, brands of the battery cells, a maximum charging current of a single battery cell and a maximum discharging current of the single battery cell.

15. The intelligent device as claimed in claim 13, wherein
the manual comparison verification process further comprises:
setting, by an operation personnel, an error tolerance rate through the human-machine interaction module; and
verifying, in response to a consistency between the configuration information input into the battery pack and the input information reaching the error tolerance rate, the configuration information input into the battery pack being consistent with the input information.

16. The intelligent device as claimed in claim 1, wherein
the production information of the battery pack comprises a production time, a production location, a production line identifier and a production amount; and
the charging and discharging information of the battery pack comprises the number of battery cells, series-parallel configuration information of the battery cells, performance of the battery cells, brands of the battery cells, a maximum charging current of a single battery cell and a maximum discharging current of the single battery cell.

17. The intelligent device as claimed in claim 1, wherein
the configuration information comprises a high and low level information.

18. The intelligent device as claimed in claim 1, wherein
a plurality of information windows are provided in the human-machine interaction module, and the information windows comprises a production information window and a charging and discharging information window.

19. The information input method as claimed in claim 6, wherein
the production information of the battery pack comprises a production time, a production location, a production line identifier and a production amount; and
the charging and discharging information of the battery pack comprises the number of battery cells, series-parallel configuration information of the battery cells, performance of the battery cells, brands of the battery cells, a maximum charging current of a single battery cell and a maximum discharging current of the single battery cell.

20. The information input method as claimed in claim 5, wherein
a plurality of information windows are provided in the human-machine interaction module, and the information windows comprises a production information window and a charging and discharging information window.

21. The information input method as claimed in claim 5, wherein
the human-machine interaction module is a module with an operational display interface, the input information of the battery pack is capable of being set through the human-machine interaction module; and
the information conversion module comprises a data conversion serial port.
